(19) United States
(12) Patent Application Publication
(10) Pub. No.: US 2021/0298132 A1
(43) Pub. Date: Sep. 23, 2021

(54) Electric Heating Device and Method of Manufacturing the Same

(71) Applicant: Eberspächer catem Hermsdorf GmbH & Co. KG, Hermsdorf (DE)

(72) Inventors: Florian Bitto-Golon, Remse (DE); Yves Knüpfer, Caaschwitz (DE); Andreas Kümpel, Wünschendorf/Elster (DE)

(21) Appl. No.: 17/202,609

(22) Filed: Mar. 16, 2021

(30) Foreign Application Priority Data
Mar. 17, 2020 (DE) 10 2020 203 390.0

(51) Int. Cl. H05B 3/50

(52) U.S. Cl. CPC H05B 3/50; H05B 2203/02

(57) ABSTRACT

An electric heating device includes a housing encompassing a PTC element and strip conductors electrically connected to the PTC element for energizing the same with different polarity. The housing is integrally molded over the PTC element and strip conductors from a polymer ceramic. A method of manufacturing such an electric heating device also is disclosed.

### BACKGROUND OF THE INVENTION

### 1. Field of the Invention

The present invention relates to an electric heating device with a housing encompassing a PTC element and strip conductors electrically connected thereto for energizing the same with different polarity.

### 2. Background of the Invention

A generic electric heating device is known, for example, from EP 1 768 459 B1. In this prior art, the PTC element is located in a position frame made of an insulating material which surrounds the PTC element circumferentially and keeps the opposite main side surfaces of the PTC element free. On these main side surfaces, contact sheets abut as strip conductors forming contact lugs integrally molded thereon, which serve for the electrical connection of the electrical heating device. Insulating layers are applied to the outer surfaces of the strip conductors opposite the PTC element. These insulating layers abut against the contact sheets with the interposition of an elastomeric adhesive. The elastomeric adhesive is bonded to the position frame. As a result, the PTC element is encompassed by the multi-part housing so that the medium to be heated or, in the case of air, any contamination or moisture carried along by the medium, cannot reach the PTC element and the strip conductors energizing it.

In an alternative solution according to the aforementioned prior art, an insulating layer abuts against the position frame in the aforementioned manner. The insulating layer provided on the opposite side has been bonded to the position frame during overmolding of the position frame.

In the previously mentioned prior art, the insulating layer consists of a plastic film with relatively good thermal conductivity and a ceramic layer. The latter also has relatively good thermal conductivity. Thus, the heat generated by the PTC element is indeed conducted through a two-layer insulating layer. However, since the insulating layer itself has relatively good thermal conductivity, this results in relatively good extraction of the heat generated by the PTC element. Thus, the efficiency of the electric heating device is relatively high, especially since the position frame made of the insulating plastic material only surrounds the end faces of the PTC element, which limit the cuboid PTC element as a narrow edge and have a relatively small surface area compared to the main side surfaces.

However, the electric heating device according to the aforementioned prior art is relatively complex in design, as various components have to be joined together.

An alternative and easier to manufacture electric heating device is known from U.S. Pat. No. 6,178,292 B1. In this prior art, an insulating plastic compound completely surrounds the strip conductors and the PTC element. Only contact lugs protrude beyond the housing formed from the plastic material.

However, the aforementioned solution can only ensure a secure enclosure of the PTC element and the strip conductors electrically connected to it if the plastic material is formed with a certain thickness around the actual heating cell. Due to the relatively poor thermal conductivity of plastic, the heat generated by the PTC element is only dissipated against a certain thermal resistance to the outside of the electrical heating device formed by the plastic.

In the prior art according to EP 2 296 432 A1, the housing is formed by a rectangular plastic tube into which several PTC elements provided in a position frame and contact surfaces abutting on both sides against the main sides are inserted. Compared with U.S. Pat. No. 6,178,292 B1, the manufacture of this electric heating device is relatively complex. The plastic frame has the same disadvantages as the plastic material according to U.S. Pat. No. 6,178,292 B1.

### SUMMARY

The present invention aims to specify an electric heating device that is easy to manufacture and has good efficiency.

In order to solve this problem, the present invention proposes to form the housing of an electric heating device of the type disclosed above as a one-piece housing molded from a polymer ceramic.

The housing is integrally formed. The polymer ceramic is formed around the heating cell consisting of the PTC element and the two strip conductors. The housing is usually produced by molding. Thus, the housing can be formed by immersing the heating cell into a bath containing the polymer ceramic. Alternatively, the housing can also be produced by injection molding. In this case, the PTC element and the strip conductors are usually inserted into the mold cavity of an injection mold. The injection mold is closed and filled with the polymer ceramic. The polymer ceramic can solidify in the mold cavity if it is a thermoplastic material. However, as a plastic component, the polymeric ceramics can also have a crosslinking plastic that crosslinks and sets or hardens in the injection mold or other mold. As a plastic component, the polymer ceramic can have any curing or setting plastic. In view of the fact that the electric heating device is heated during operation, which causes thermoplastics to melt or at least age rapidly, thermosetting plastics with a ceramic filler portion are preferable.

The electric heating device according to the present invention is suitable, for example, for the use in motor vehicles, in particular as a heat-generating cell for heating air which is introduced into the vehicle interior, or a liquid temperature control medium which circulates in the vehicle, or for heating individual units such as batteries, fuel cells or the like. Due to the very good insulating properties of the polymer ceramics, the electric heating device according to the present invention can also be used in electric vehicles operated with high voltage, wherein this operating voltage can also be used to heat the PTC element and accordingly introduced into the electrical heating device.

Nevertheless, the polymer ceramic can be formed with a sufficient layer thickness around the heating cell without significantly reducing the efficiency of the heating device. This is because the good thermal conductivity of the polymer ceramic ensures good extraction of the heat generated by the PTC element.

Forming a uniform layer of the polymer ceramic housing around the heating cell results in increased electrical safety. A cuboid PTC element is usually coated or surrounded with the polymer ceramic on seven of the eight side surfaces. Only on one of the side surfaces can the housing and thus the PTC element preferably be surmounted on one side by contact lugs which are electrically conductively connected to the strip conductors. These contact lugs are used for the electrical connection of the electric heating device to a power source. They are usually formed as male plug contacts of a plug connection. The PTC element is usually completely surrounded by the polymer ceramic.

In a manner known, per se, from the aforementioned prior art, the strip conductors and the contact lugs are each preferably formed individually from a contact sheet. In the process according to the invention, each of the contact sheets is preferably connected to the PTC element. In this way, an assembly is created which is formed by the heating cell per se and is shaped as a unit. The contact sheets and the PTC element can be joined together with an electrically conductive adhesive or the like. It is also possible to solder the contact sheets to the PTC element or to connect them by other means.

An electrically conductive adhesive can be added with electrically conductive particles so that good electrical conductivity is ensured between the contact sheets and the PTC element. The PTC element usually has a metallization on opposite main side surfaces against which the contact sheet is electrically conductively bonded. This metallization can have certain roughnesses which can also penetrate an electrically non-conductive adhesive and thus ensure sufficient contact between the contact sheets and the PTC element. In a preferred method, the assembly formed in this way is inserted into a mold cavity. The contact lugs projecting beyond the PTC element are used to hold the assembly in place during the molding of the housing. Thus, when a still flowable polymer ceramic is inserted into the mold cavity, the contact lugs are separated from the mold cavity and not wetted with the polymer ceramic. If the housing is produced in an immersion bath, the assembly is introduced into the immersion bath with the contact lugs protruding above the immersion bath. This also ensures that the contact lugs are immediately available for electrical contacting of the PTC element after the housing has been molded.

### BRIEF DESCRIPTION OF THE DRAWINGS

Further details and advantages of the present invention will become apparent from the enclosed description of an embodiment income nation with the drawings, in which drawings

FIG. 1 is a perspective side view of an embodiment of the present invention; and

FIG. 2 is a cross-sectional view along lines II-II according to FIG. 1.

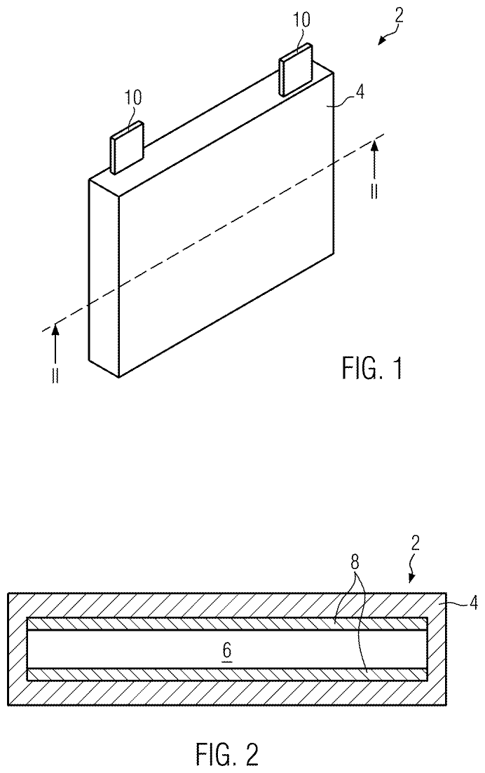

### DETAILED DESCRIPTION

In the figures, reference number 2 identifies an electric heating device. The electric heating device 2 has a housing 4 encompassing a PTC element 6 and strip conductors 8. The strip conductors 8 are electrically connected to the PTC element 6 for energizing the same with different polarity. The housing 2 is a one-piece housing formed from a polymer ceramic.

The polymer ceramic is molded around the PTC element 6 and the strip conductors 8 by a thermoset injection molding process. Thus, the PTC element 6 and the strip conductors 8 are completely sealed within the polymer ceramic Only contact lugs 10 formed by free ends of sheet metal pieces defining the strip conductors 8 project beyond the housing 4.

The polymer ceramic of the embodiment is an inorganic-organic composite consisting of ceramic fillers of e.g. Al₂O₃ and a matrix of organo silicon polymers—primarily polysiloxanes. The formation of the housing by the polymer ceramic is based on the chemical crosslinking of functionalized resins, which can be further transformed into ceramic-like structures by thermal post-treatment. The polymer ceramics have a high thermal stability and also a low shrinkage, high dimensional stability and dimensional stability. Relevant service properties (e.g. electrical conductivity, thermal conductivity, dielectric properties) and processing parameters can be adapted to the specific application of a heater within a motor vehicle, in which the inventive electric heating device will be employed, by selecting suitable functional fillers and binder systems. The use of polymer-ceramic materials allows cost-effective, simple processing of the material and provides high thermal stability of the housing 4.

1. An electric heating device comprising:
a PTC element;
strip conductors electrically connected to the PTC element for energizing the same with different polarity; and
a housing encompassing the PTC element and the strip conductors,
wherein the housing is a one-piece housing formed from a polymer ceramic

2. The electric heating device according to claim 1, wherein the housing is surmounted on one side by a contact lug that is electrically conductively connected to the strip conductors.

3. The electric heating device according to claim 2, wherein a contact sheet forms the strip conductor and the contact lug.

4. The electric heating device according to claim 2, wherein at least two conduct lugs are provided and are configured to provide an electrical connection of the electric heating device to a power source.

5. A method of manufacturing an electric heating device including with a housing which encompasses a PTC element and strip conductors electrically connected thereto for energizing the same with different polarity, the method comprising:
inserting the PTC element and the strip conductors into a mold cavity;
surrounding the PTC element and the strip conductors by a polymer ceramic; and
solidifying the polymer ceramic to form the housing.

6. The method according to claim 5, wherein the PTC element is connected to contact sheets forming the strip conductor and a contact lug, and the thus produced assembly is held in place during molding of the housing via the projecting of the contact lug beyond the PTC element.

7. The method according to claim 6, wherein at least two conduct lugs are provided and are configured to provide an electrical connection of the electric heating device to a power source.

8. The method according to claim 6, wherein the housing is injection molded.

9. The method according to claim 5, wherein the housing is injection molded.
